(19) United States
(12) Patent Application Publication
(10) Pub. No.: US 2015/0306752 A1
(43) Pub. Date: Oct. 29, 2015

(54) PNEUMATIC NAIL GUN

(71) Applicant: Basso Industry Corp., Taichung (TW)

(72) Inventors: Yao-Sheng SHEN, Taichung (TW); An-Gi LIU, Taichung (TW); Fu-Yi HUANG, Taichung (TW)

(73) Assignee: Basso Industry Corp., Taichung (TW)

(21) Appl. No.: 14/260,296

(22) Filed: Apr. 24, 2014

(51) Int. Cl. B25C 1/00; B25C 1/04

(52) U.S. Cl. CPC B25C 1/008; B25C 1/04

(57) ABSTRACT

A pneumatic nail gun includes a nail-gun main body, a first trigger, an auxiliary handle, an insurance unit, and an auxiliary insurance mechanism. The first trigger is disposed in the nail-gun main body. The auxiliary handle is extended from the nail-gun main body. The insurance unit is disposed at a nail outlet of the nail-gun main body and being capable of shifting between a non-firing location and a location to be fired. The auxiliary insurance mechanism includes a second trigger and an insurance stopper element. The second trigger is disposed on the auxiliary handle. The insurance stopper element is disposed in the nail-gun main body. The insurance stopper element is capable of shifting between a first location and a second location as controlled by operation of the second trigger so as to selectively block a shifting path of the insurance unit.

### BACKGROUND

1. Technical Field

The present disclosure relates to a pneumatic nail gun. More particularly, the present disclosure relates to a pneumatic nail gun having a double insurance mechanism.

2. Description of Related Art

A conventional pneumatic nail gun is communicated to a source compressed gas, and includes a nail-gun main body and a trigger disposed on the nail-gun main body. When a user pulls the trigger, a nail is fired out from a nail outlet of the nail-gun main body.

For the purpose of avoiding accidentally firing the nail as a result of carelessly pulling the trigger by the user, or for the purpose of avoiding the user from using the pneumatic nail gun in an incorrect manner, in some pneumatic nail gun an insurance unit is disposed at the nail outlet of the nail-gun main body. The insurance unit can shift between a non-firing location and a location to be fired. In a non-operating condition, the insurance unit is protruded relative to the nail outlet and is thus disposed at a non-firing location. At this point, the trigger of the pneumatic nail gun cannot be pulled, or alternatively the trigger can be pulled but no nail is fired.

When the nail outlet abuts against an operating surface as operated by a user, the insurance unit reaches the location to be fired as pushed by the operating surface, and only at this point can the user push the trigger to fire the nail smoothly.

However, there are still security flaws in the conventional pneumatic nail gun. For example, when the aforesaid insurance unit accidentally abuts against a body part (such as a hand or foot) of the user or other positions at which nailing is originally not required, then as accordingly the insurance unit moves to the location to be fired, it is still possible that the pneumatic nail gun is actuated by mistake. Therefore there is a need to solve such a problem.

The Patent No. TW I352652 discloses a pneumatic nail gun having a pneumatic auxiliary handle, wherein the auxiliary handle is used to control whether conducting the high-pressure gas or not, so that in order to fire a nail smoothly, the user has to simultaneously pull a trigger of the pneumatic auxiliary handle and an activating main trigger of the nail gun respectively with two hands.

However, the Patent No. TW I352652 still has security flaws as the control of actuation of the pneumatic auxiliary handle is not linked with the action of the aforesaid insurance unit, and this patent even proposes that the nailing operation can be performed without abutting the pneumatic nail gun against a workpiece (that is, when the user pulls the two triggers at the same time, a nail is fired no matter the pneumatic nail gun abuts the surface to be nailed or not). Therefore, it cannot consider that such a design has already reached a high-level security and protection.

### SUMMARY

In view of the above, the disclosure is mainly directed to provide a pneumatic nail gun having a double insurance mechanism.

In order to achieve the aforesaid and other aims, the disclosure provides a pneumatic nail gun communicated to a source of compressed gas. The pneumatic nail gun includes a nail-gun main body, a first trigger, an auxiliary handle, an insurance unit and an auxiliary insurance mechanism. The first trigger is disposed in the nail-gun main body. The auxiliary handle is extended from the nail-gun main body. The insurance unit is disposed at a nail outlet of the nail-gun main body, and is capable of shifting between a non-firing location and a location to be fired. The auxiliary insurance mechanism includes a second trigger and an insurance stopper element. The second trigger disposed on the auxiliary handle. The insurance stopper element is disposed in the nail-gun main body. The insurance stopper element is capable of shifting between a first location and a second location as controlled by operation of the second trigger so as to selectively block a shifting path of the insurance unit. When the user uses one hand to operate the second trigger so as to control the shift of the insurance stopper element to enable the insurance unit to shift to the location to be fired, and the user has to use the other hand to operate the first trigger.

With the aforesaid structure, in addition to the insurance mechanism owned by the conventional pneumatic nail gun, in the disclosure by adding an auxiliary insurance mechanism, the insurance unit can freely move only after the user moves the insurance stopper element to an appropriate location, otherwise even the insurance unit itself cannot reach the location to be fired so that actuation of the pneumatic nail gun by mistake is avoided.

It is to be understood that both the foregoing general description and the following detailed description are by examples, and are intended to provide further explanation of the disclosure as claimed.

### BRIEF DESCRIPTION OF THE DRAWINGS

FIG. 1 is a perspective view of a first preferred embodiment of the disclosure;

FIG. 2 is an exploded view of the first preferred embodiment of the disclosure;

FIG. 3 is a cross-sectional view taken along a section line A-A in FIG. 1, wherein a valve lever is positioned at a third location;

FIG. 4 is a cross-sectional view taken along a section line B-B in FIG. 1, wherein the valve lever is positioned at the third location;

FIG. 5 is a cross-sectional view similar to FIG. 3, wherein the valve lever is positioned at a fourth location;

FIG. 6 is a cross-sectional view similar to FIG. 4, wherein the valve lever is positioned at the fourth location;

FIG. 7 is a partially enlarged view of FIG. 6;

FIG. 8 is a perspective view of a second preferred embodiment of the disclosure;

FIG. 9 is an exploded view of the second preferred embodiment of the disclosure;

FIG. 10 is a cross-sectional view taken along a section line A-A in FIG.8, wherein the valve, lever is positioned at the fourth location;

FIG. 11 is a cross-sectional view taken along a section line B-B in FIG. 8, wherein the valve lever is positioned at the fourth location;

FIG. 12 is partially enlarged view of FIG. 11;

FIG. 13 is a cross-sectional view similar to FIG. 10, wherein the valve lever is positioned at the third location;

FIG. 14 is a cross-sectional view similar to FIG. 11, wherein the valve lever is positioned at the third location;

FIG. 15 is a perspective view of a third preferred embodiment of the disclosure, wherein a insurance stopper element is positioned at a first location; and

FIG. 16 is another perspective view of the third preferred embodiment of the disclosure, wherein the insurance stopper element is positioned at a second location.

### DETAILED DESCRIPTION

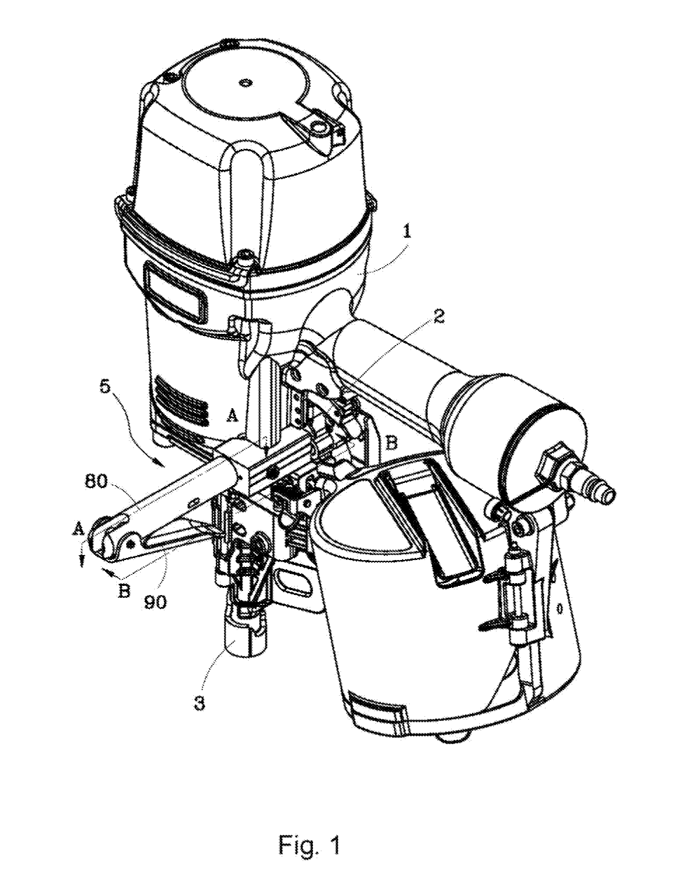

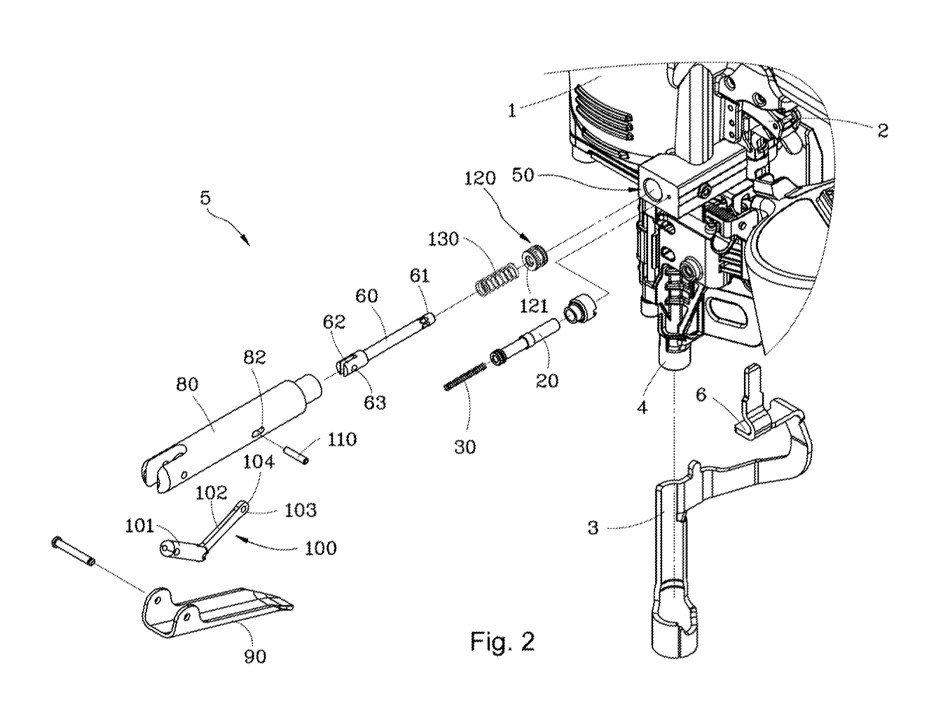

Referring to FIGS. 1 and 2, in a first preferred embodiment of the disclosure, a pneumatic nail gun has a nail-gun main body 1, a first trigger 2 disposed on the nail-gun main body 1, an insurance unit 3 disposed at a nail outlet 4 of the nail-gun main body 1, and an auxiliary insurance mechanism 5, wherein the nail-gun main body 1 is communicated to a source of compressed gas (such as an air compressor which is not shown), and the insurance unit 3 can shift between a non-firing location and a location to be fired; when the insurance unit 3 is disposed at the non-firing location, the first trigger 2 cannot be pulled, or alternatively even if the first trigger 2 is pulled, no nail is fired; and when the insurance unit 3 is disposed at the location to be fired, the first trigger 2 can be pulled and a nail is accordingly fired; and since the linkage mechanism between actions of the first trigger 2 and the insurance unit 3 is not the creative focus of the disclosure and belongs to the scope of the prior art, it will not be recited again.

Referring to FIGS. 1-4, the auxiliary insurance mechanism 5 includes a stopper element accommodation groove 10, an insurance stopper element 20, a first elastic member 30 and a control means. The control means is used to control the shifting of the insurance stopper element 20, and includes a second passage 40, a valve lever accommodation groove 50, a valve lever 60 and a third passage 70.

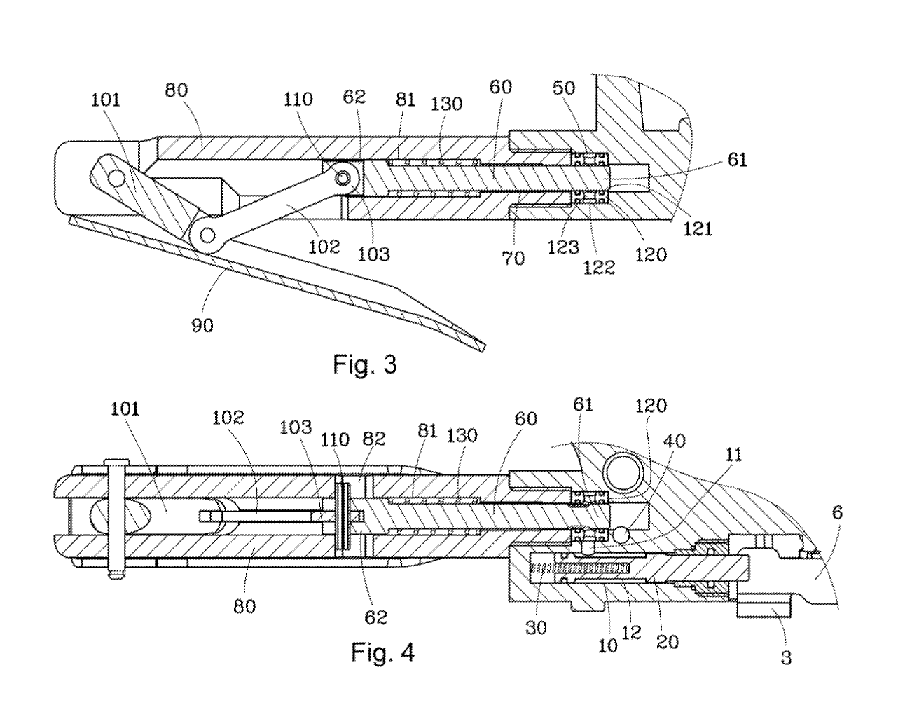

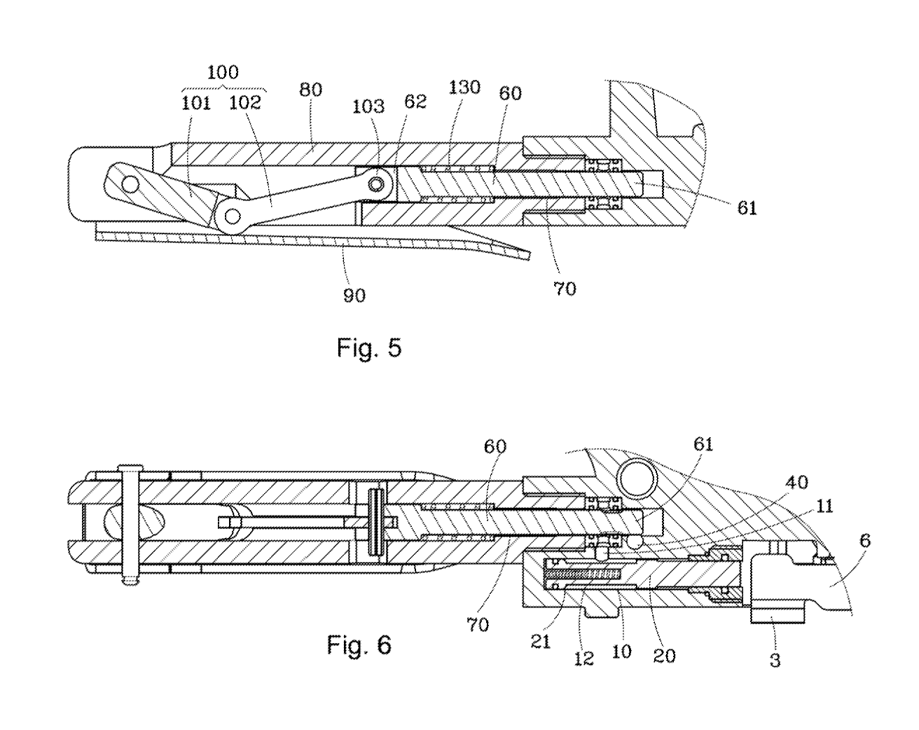

The stopper element accommodation groove 10 is disposed in the nail-gun main body 1 and has a first passage 11 which communicates the stopper element accommodation groove 10 to the valve lever accommodation groove 50. The insurance stopper element 20 is disposed in the stopper element accommodation groove 10 and can shift between a first location (as shown in FIGS. 3 and 4) and a second location (as shown in FIGS. 5 and 6) so as to block the shifting path of the insurance unit 3. A pneumatic chamber 12 communicated to the first passage 11 is defined between the stopper element accommodation groove 10 and the insurance stopper element 20. In this embodiment, the insurance unit 3 has a stop surface 6 which can be selectively blocked by the insurance stopper element 20 so as to prevent the insurance unit 3 from moving from a non-firing location to the location to be fired.

The first elastic member 30 is disposed in the stopper element accommodation groove 10, and provides a pre-elastic force for moving the insurance stopper element 20 to the first location.

The second passage 40 is communicated to the source of compressed gas of the nail-gun main body 1, so as to direct the compressed gas provided from the source of compressed gas. That is, the second passage 40 is disposed as communicated to the valve lever accommodation groove 50 and is further communicated to the nail-gun main body 1.

The valve lever accommodation groove 50 is communicated between the first passage 11 and the second passage 40, and the valve lever 60 has a head portion 61 disposed in the valve lever accommodation groove 50, and is capable of shifting between a third location (as shown in FIGS. 3 and 4) and a fourth location (as shown in FIGS. 5 and 6).

The third passage 70 is communicated between the first passage 11 and the outside.

As shown in FIGS. 3 and 4, when the valve lever 60 is positioned at the third location, the head portion 61 of the valve lever 60 blocks between the first passage 11 and the second passage 40 such that the first passage 11 and the second passage 40 are isolated, and at this point the insurance stopper element 20 shifts to the first location as pushed by the first elastic member 30 so as to block the shifting path of the insurance unit 3. As such, even if the insurance unit 3 is abutted against, the stop surface 6 is stopped by the end portion of the insurance stopper element 20, so that the insurance unit 3 is avoided from moving from the non-firing location to the location to be fired; and additionally at this point the first passage 11 and the third passage 70 are communicated to each other, such that the residual pressure in the pneumatic chamber 12 can be released via the third passage 70.

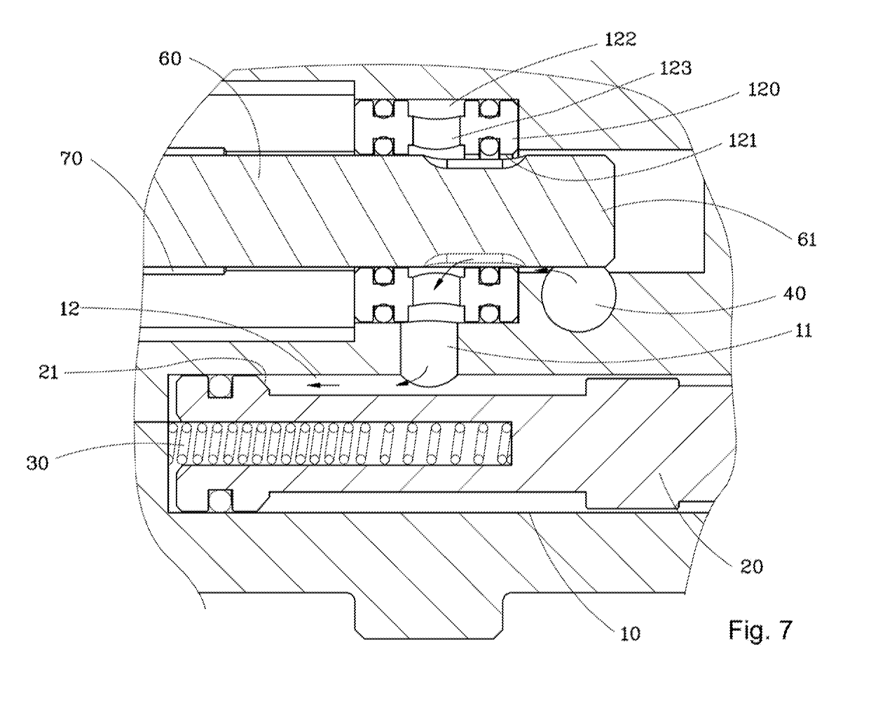

Furthermore, as shown in FIGS. 5-7, when the valve lever 60 is positioned at the fourth location, the first passage 11 and the second passage 40 are communicated to each other, such that the compressed gas from the source of compressed gas is transmitted sequentially through the second passage 40 and the first passage 11, and then the compressed gas is transmitted into the pneumatic chamber 12. The compressed gas exerts a force on a push surface 21 of the insurance stopper element 20 so as to push the insurance stopper element 20 to the second location. At this point the insurance stopper element 20 does not block the shifting path of the insurance unit 3, so that the insurance unit 3 can freely shift between the non-firing location and the location to be fired. Additionally at this point, the head portion 61 of the valve lever 60 blocks between the first passage 11 and the third passage 70 to avoid gas pressure in the pneumatic chamber 12 from releasing via the third passage 70.

Based on the aforesaid structure, the nail is fired only when the user operate as follows: using one hand to control the valve lever 60, then making the nail outlet 4 abut against an operating surface to push the insurance unit 3 against the location to be fired, such that the pneumatic nail gun is in a stated to be actuated; and then using the other hand to pull the first trigger 2. Such pneumatic nail gun having a double insurance mechanism (the insurance unit 3 and the auxiliary insurance mechanism 5) can ensure that the nail is fired only when the user uses both hands to operate the pneumatic nail gun and pushes the insurance unit 3 against the location to be fired, thereby the possibility of firing the nail by mistake is significantly reduced.

In this preferred embodiment, an auxiliary handle 80 extends from the nail-gun main body 1 and is connected to the valve lever accommodation groove 50, and the control means of the auxiliary insurance mechanism 5 further has a second trigger 90 pivotally disposed in the auxiliary handle 80 and a pair of connecting rods 100 controlled by the second trigger 90. The pair of connecting rods 100 has a first connecting rod 101 and a second connecting rod 102. The first connecting rod 101 is pivotally and coaxially disposed on the auxiliary handle 80 together with the second trigger 90. The second connecting rod 102 is pivotally disposed between the first connecting rod 101 and the valve lever 60. As such, the user can press the second trigger 90 to enable the pair of connecting rods 100 to push shifting of the valve lever 60. Moreover, the auxiliary handle 80 is provided with the valve lever 60 therein, and the function of the valve lever 60 of opening or closing the compressed-gas source of the main body is driven by the second trigger 90, so as to control gas from the source of compressed gas to pass through the first passage 11 to enable the insurance stopper element 20 to act at the first location or the second location.

In order to make the valve lever 60 shift smoothly, the control means of the auxiliary insurance mechanism 5 further includes a guide rod 110. The valve lever 60 has a pivot end 62 and a pivot hole 63 disposed at the pivot end 62. The second connecting rod 102 has an abutting end 103 pivotally connected to the pivot end 62, and an abutting hole 104 disposed at the abutting end 103. The auxiliary handle 80 has an accommodation groove 81 used for accommodating the pivot end 62 of the valve lever 60 and an elongated slot 82 communicated to the accommodation groove 81. The guide rod 110 penetrates the pivot hole 63 and the abutting hole 104 and is partially protruded into the elongated slot 82, such that the guide rod 110 can shift along the elongated slot 82 to direct the valve lever 60 to smoothly shift between the third and fourth locations.

Moreover, the control means of the auxiliary insurance mechanism 5 also includes a valve block 120 disposed in the valve lever accommodation groove 50. The valve block 120 has a through hole 121, a ring groove 122 corresponding to the first passage 11, and several openings 123 communicated between the through hole 121 and the ring groove 122. Two ends of the through hole 121 are respectively communicated to the second passage 40 and the third passage 70. The head portion 61 of the valve lever 60 movably penetrates the through hole 121, and the internal and external surfaces of the valve block 120 are provided with several sealing rings for improving gas tightness.

Additionally, in order to facilitate restoration of the valve lever 60 the control means of the auxiliary insurance mechanism 5 of this preferred embodiment further includes a second elastic member 130. The second elastic member 130 is disposed in the auxiliary handle 80 to provide a pre-elastic force for putting the valve lever 60 back to the third location.

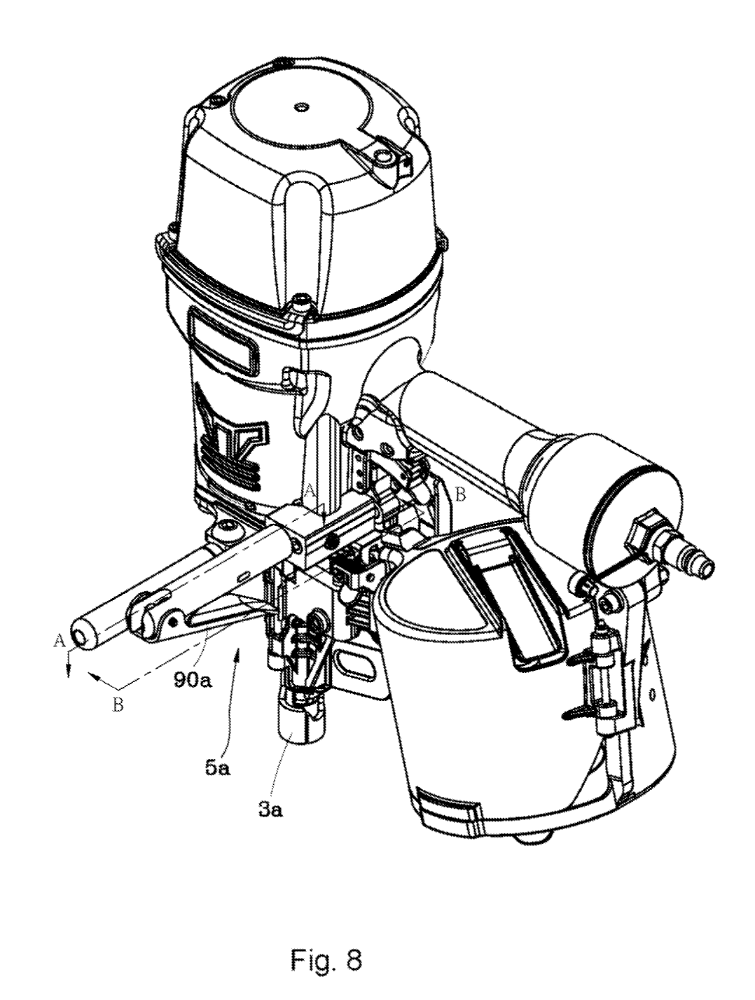

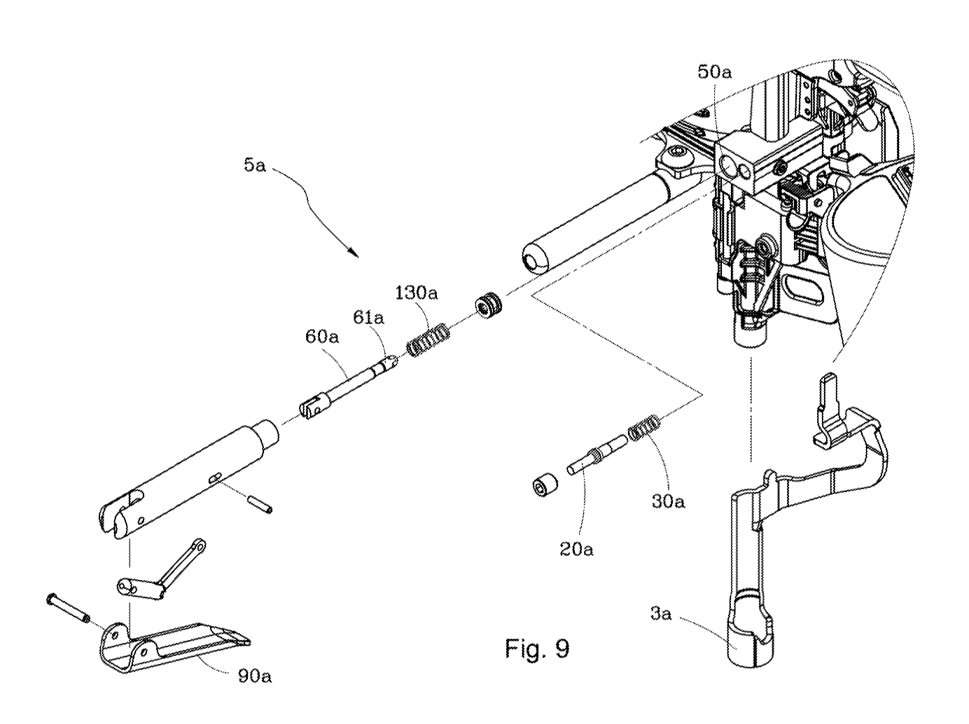

Referring to FIGS. 8-11, a second preferred embodiment of the disclosure provides a pneumatic nail gun similar to the one described in the aforesaid embodiment. That is, the auxiliary insurance mechanism 5a of this embodiment also includes a stopper element accommodation groove 10a, an insurance stopper element 20a, a first elastic member 30a and a control means. The control means also includes a second passage 40a, a valve lever accommodation groove 50a, a valve lever 60a and the like components, and similarly when the valve lever 60a is not controlled under a force applied by the user, the insurance stopper element 20a blocks the travel of the insurance unit 3a. The main difference between the first and second preferred embodiments is that the action directions of the valve levers 60 and 60a are opposite, and the second elastic member 130a of this embodiment is used to provide the pre-elastic force for putting the valve lever 60a back to the fourth location which is different from the first preferred embodiment where the second elastic member 130 is used to provide the pre-elastic force for putting the valve lever 60 back to the third location.

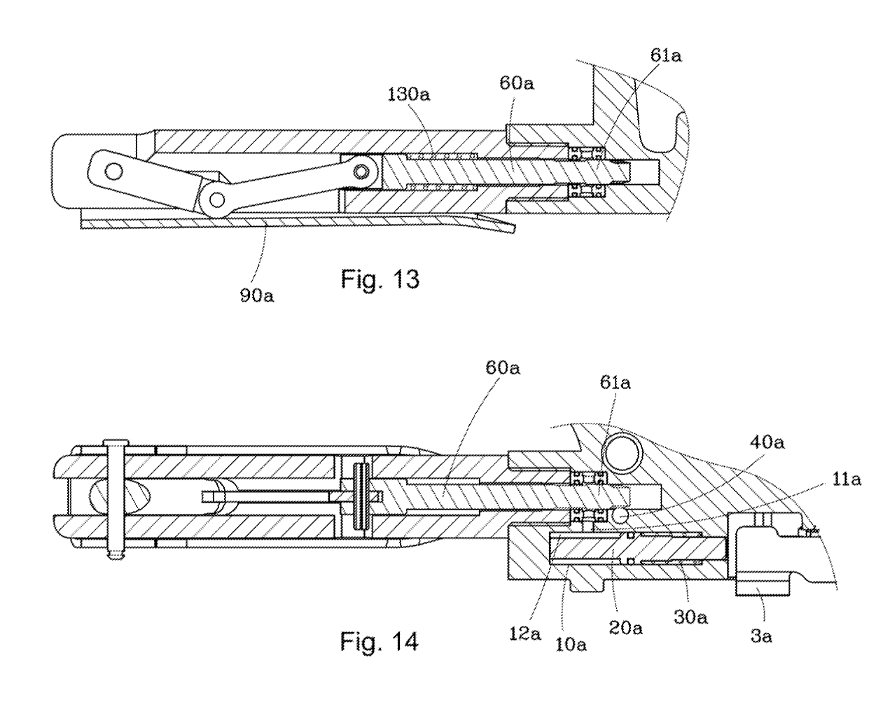

As shown in FIGS. 13 and 14, when the valve lever 60a moves to the third location as operated by the user (in this embodiment similarly controlled by pressing the second trigger 90a), the head portion 61a of the valve lever 60a blocks between the first passage 11a and the second passage 40a, such that the compressed gas cannot enter the pneumatic chamber 12a and then the insurance stopper element 20a shifts to the first location as pushed by the first elastic member 30a; and different from the first preferred embodiment, when the insurance stopper element 20a of this embodiment is positioned at the first location, the shifting path of the insurance unit 3a is not blocked, so that the insurance unit 3a can freely move between the non-firing location and the location to be fired.

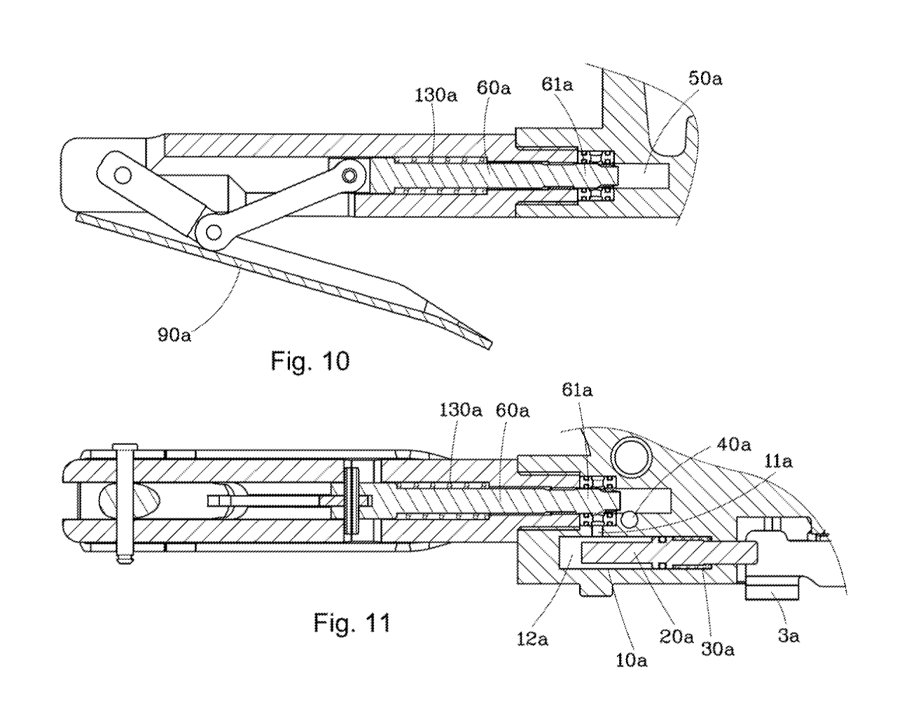

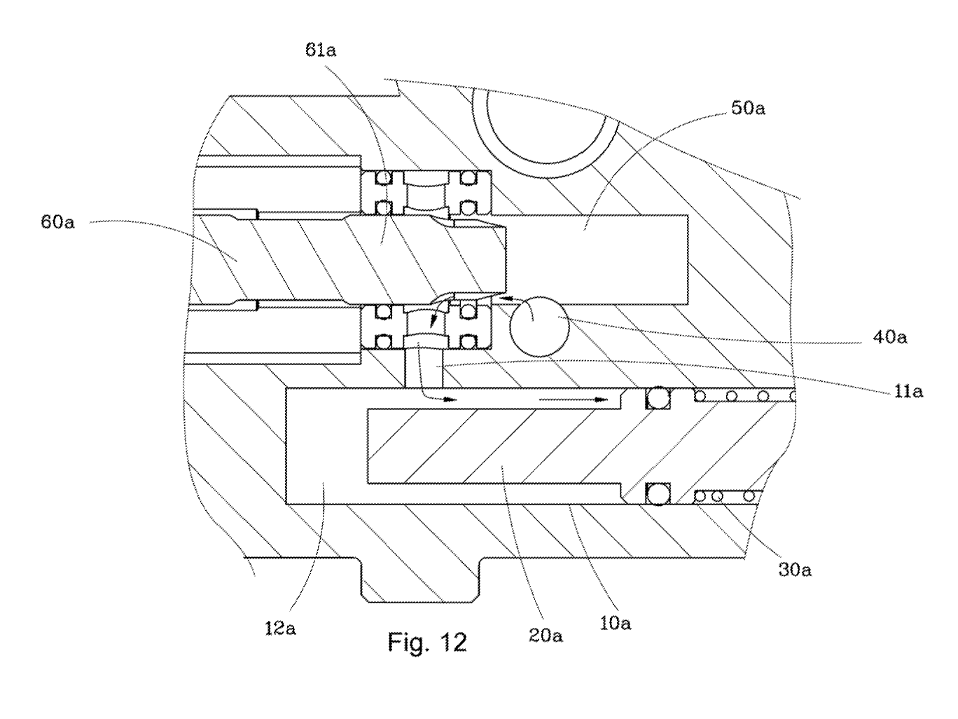

As shown in FIGS. 10-12, when the valve lever 60a is restored to the fourth location as pushed by the second elastic member 130a, the first passage 11a and the second passage 40a are communicated to each other, such that the compressed gas enters through the first passage 11a, into the pneumatic chamber 12a, so as to push the insurance stopper element 20a to the second location; and different from the first preferred embodiment, when the insurance stopper element 20a of this embodiment is positioned at the second location, the shifting path of the insurance unit 3a is blocked by the end portion of the insurance stopper element 20a, such that the insurance unit 3a cannot move from the non-firing location to the a location to be fired, thereby the pneumatic nail gun having a double insurance mechanism is achieved.

It should be illustrated that in other possible embodiments of the disclosure, the user also can use other control means to control the valve lever. As an example, a free end of the valve lever is exposed to outside, such that the user can perform controlling by directly pressing the valve lever. In other possible embodiments of the disclosure, the third passage may be omitted and the residual pressure of the pneumatic chamber is released in other manners. For example, other pressure release valves or pressure release channels are directly arranged in the pneumatic chamber and are controlled in appropriate manners.

Additionally, in the aforesaid two preferred embodiments, the control means is shifting the valve lever to control whether pushing the insurance stopper element or not. That is the control means is a pneumatic control means, although the control means of the disclosure also includes purely mechanical control means.

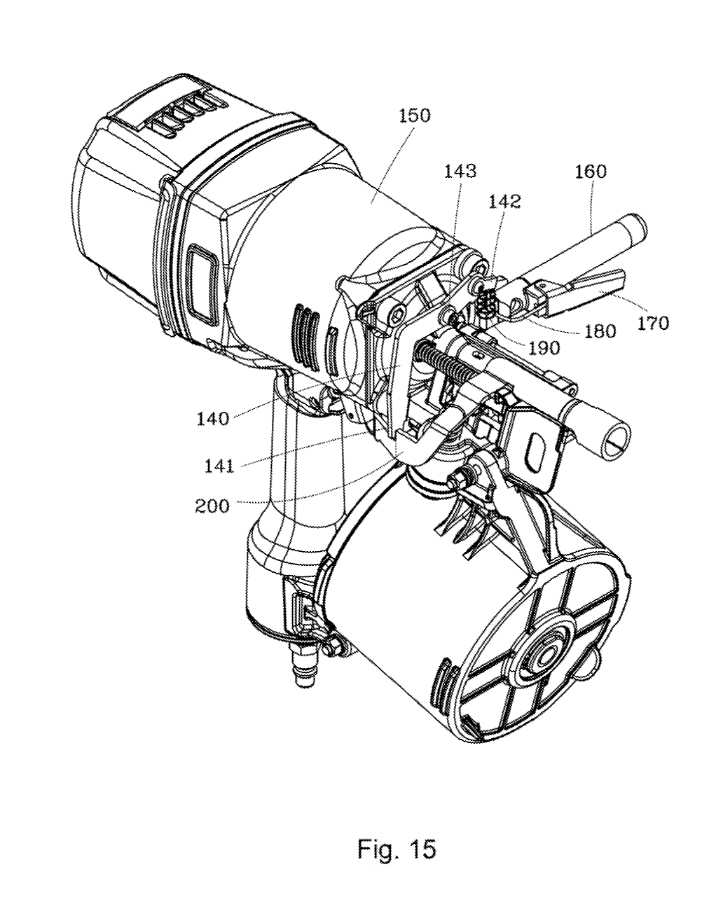

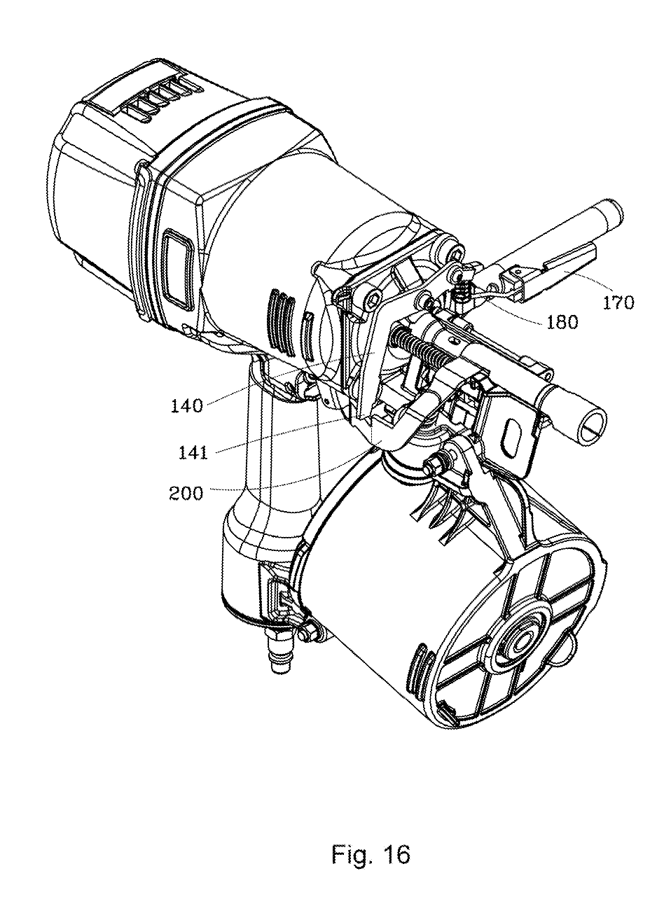

Referring to FIG. 15, the structure difference between the pneumatic nail gun provided in a third preferred embodiment of the disclosure and those provided in the aforesaid two embodiments is that the pneumatic control means used, in the aforesaid two embodiments is replaced by a purely mechanical control means; in this embodiment the insurance stopper element 140 is pivotally disposed in the nail-gun main body 150 so as to shift between the first location (as shown in FIG. 15) and the second location (as shown in FIG. 16); the insurance stopper element 140 has a stopping end 141 and a control end 142 respectively arranged at two sides of a pivot shaft 143; and the control means of this embodiment includes a auxiliary handle 160 connected to the nail-gun main body 150, a second trigger 170 pivotally disposed on the auxiliary handle 160, and a steel rope 180 connected between the second trigger 170 and the insurance stopper element 140.

As shown in FIG. 15, when the second trigger 170 is not pressed by the user, the control end 142 of the insurance stopper element 140 is positioned at the first location as pushed by the first elastic member 190, and at this point the stopping end 141 of the insurance stopper element 140 blocks the shifting path of the insurance unit 200, such that the insurance unit 200 cannot move from the non-firing location to the location to be fired, and additionally the control end 142 can be set as linked with the second trigger 170 so as to act together with the second trigger 170.

As shown in FIG. 16, when the second trigger 170 is pressed by the user, the steel rope 180 is pulled by the second trigger 170 and the control end 142 is driven to shift, such that the insurance stopper element 140 pivotally moves to the second location. At this point the stopping end 141 of the insurance stopper element 140 does not block the shifting path of the insurance unit 200, such that the insurance unit 200 can freely move to the location to be fired when abutting against the operating surface.

Such a mechanical control means is advantageous in that the configuration number of gas flowing passages can be reduced; the gas loss is less; such a control means is adapted to operation of continuously firing; and it is convenient to install and maintain. It should also be illustrated that the mechanical control means is not limited to that shown in the third preferred embodiment. For example, the second trigger can be changed into a shifter lever, a rotary knob or the like form; the steel rope can be replaced by other conveying mechanisms such as a connecting rod set, a gear train and a conveying chain; and it is also not necessary to use the mechanical control means together with a insurance stopper element capable of swinging. That is, the insurance stopper element can be changed as capable of linearly shifting under the control of the mechanical control means, and disposed at an appropriate position of the nail-gun main body.

Additionally, in order to adapt the pneumatic nail gun of the disclosure to the habits and ergonomic requirement of the user during operating, in the aforesaid three embodiments, the long-axis direction of the nail-gun main body is the first direction (such as the orientation of X axis); the long-axis direction of the auxiliary handle is the second direction (such as the orientation of Y axis); the shifting path of the insurance unit is the third direction (such as the orientation of Z axis); and the first, second and third directions are vertical to each other, such that the user can grip the nail gun during operating. Certainly, in other possible implementation aspects, these directions may be not vertical to each other.

At last, it should be noted that the construction components disclosed in the aforesaid embodiments are only illustrative and not intended to limit the scope of the disclosure. Other equivalent replacements or modifications of the components are also protected by the scope of the claims of the disclosure.

What is claimed is:

1. A pneumatic nail gun communicated to a source of compressed gas, comprising a nail-gun main body, a first trigger disposed in the nail-gun main body, an auxiliary handle extended from the nail-gun main body, and an insurance unit disposed at a nail outlet of the nail-gun main body and being capable of shifting between a non-firing location and a location to be fired, characterized in that the pneumatic nail gun further comprises an auxiliary insurance mechanism, and the auxiliary insurance mechanism comprises:
a second trigger disposed on the auxiliary handle; and
an insurance stopper element disposed in the nail-gun main body, wherein the insurance stopper element is capable of shifting between a first location and a second location as controlled by operation of the second trigger so as to selectively block a shifting path of the insurance unit;
wherein the user uses one hand to operate the second trigger so as to control the shift of the insurance stopper element to enable the insurance unit to shift to the location to be fired, and the user uses the other hand to operate the first trigger.

2. The pneumatic nail gun of claim 1, wherein the auxiliary insurance mechanism further comprises a first elastic member abutting against the insurance stopper element, and the first elastic member provides a pre-elastic force for putting the insurance stopper element back to the first location.

3. The pneumatic nail gun of claim 1, wherein the auxiliary insurance mechanism further comprises a second passage which is communicated to the source of compressed gas together with the nail-gun main body, the auxiliary handle comprises a valve lever, and the function of the valve lever of opening or closing the compressed-gas source of the main body is driven by the second trigger, so as to control the insurance stopper element to act at the first location or the second location.

4. The pneumatic nail gun of claim 3, wherein the auxiliary insurance mechanism further comprises:
a stopper element accommodation groove, in which the insurance stopper element is movably disposed;
a valve lever accommodation groove, in which the valve lever is movably disposed; and
a first passage for communicating the stopper element accommodation groove and the valve lever accommodation groove;
wherein the source of compressed gas is enabled to control move of the stopper element via the first passage by linking the action of the valve lever to the second trigger.

5. The pneumatic nail gun of claim 4, wherein the auxiliary insurance mechanism further comprises a pneumatic chamber defined between the stopper element accommodation groove and the insurance stopper element, and the pneumatic chamber is communicated to the first passage;
wherein the valve lever has a head portion disposed in the valve lever accommodation groove, which is capable of shifting between a third location and a fourth location, and the valve lever is driven by the second trigger;
wherein when the valve lever is positioned at the third location, the head portion of the valve lever blocks between the first passage and the second passage, and the insurance stopper element shifts to the first location as pushed by the first elastic member;
wherein when the valve lever is positioned at the fourth location, the first passage and the second passage are communicated to each other, such that a compressed gas from the source of compressed gas is transmitted through the first passage and into the pneumatic chamber to push the insurance stopper element to the second location.

6. The pneumatic nail gun of claim 5, wherein when the insurance stopper element is positioned at the first location, an end portion of the insurance stopper element blocks the shifting path of the insurance unit, and when the insurance stopper element is positioned at the second location, the shifting path of the insurance unit is not blocked.

7. The pneumatic nail gun of claim 6, wherein the auxiliary insurance mechanism further comprises a second elastic member used to provide a pre-elastic force for putting the valve lever back to the third location.

8. The pneumatic nail gun of claim 5, wherein when the insurance stopper element is positioned at the second location, an end portion of the insurance stopper element blocks the shifting path of the insurance unit, and when the insurance stopper element is positioned at the first location, the shifting path of the insurance unit is not blocked.

9. The pneumatic nail gun of claim 8, wherein the auxiliary insurance mechanism further comprises a second elastic member used to provide a pre-elastic force for putting the valve lever back to the fourth location.

10. The pneumatic nail gun of claim 3, wherein the auxiliary insurance mechanism further comprises a pair of connecting rods under the control of the second trigger, and the pair of connecting rods has a first connecting rod pivotally disposed on the auxiliary handle and a second connecting rod pivotally disposed between the first connecting rod and the valve lever.

11. The pneumatic nail gun of claim 4, wherein the second passage of the auxiliary insurance mechanism is disposed as communicated to the valve lever accommodation groove, and is also communicated to the nail-gun main body.

12. The pneumatic nail gun of claim 3, wherein a long-axis direction of the nail-gun main body is a first direction, a long-axis direction of the auxiliary handle is a second direction, the shifting path of the insurance unit is a third direction, and the first, second and third directions are vertical to each other.

13. The pneumatic nail gun of claim 5, wherein the auxiliary insurance mechanism further comprises a third passage communicated between the first passage and the outside;
wherein when the valve lever is positioned at the fourth location, the head portion of the valve lever blocks between the first passage and the third passage;
wherein when the valve lever is positioned at the third location, the first passage and the third passage are communicated to each other.

14. The pneumatic nail gun of claim 6, wherein the auxiliary insurance mechanism further comprises a third passage communicated between the first passage and the outside;
wherein when the valve lever is positioned at the fourth location, the head portion of the valve lever blocks between the first passage and the third passage;
wherein when the valve lever is positioned at the third location, the first passage and the third passage are communicated to each other.

15. The pneumatic nail gun of claim 7, wherein the auxiliary insurance mechanism further comprises a third passage communicated between the first passage and the outside;
wherein when the valve lever is positioned at the fourth location, the head portion of the valve lever blocks between the first passage and the third passage;
wherein when the valve lever is positioned at the third location, the first passage and the third passage are communicated to each other.

16. The pneumatic nail gun of claim 8, wherein the auxiliary insurance mechanism further comprises a third passage communicated between the first passage and the outside;
wherein when the valve lever is positioned at the fourth location, the head portion of the valve lever blocks between the first passage and the third passage;
wherein when the valve lever is positioned at the third location, the first passage and the third passage are communicated to each other.

17. The pneumatic nail gun of claim 13, wherein the auxiliary insurance mechanism further comprises a valve block disposed in the valve lever accommodation groove, and the valve block comprises:
a through hole;
a ring groove corresponding to the first passage; and
several openings communicated between the through hole and the ring groove;
wherein two ends of the through hole are respectively communicated to the second passage and the third passage, and the head portion of the valve lever movably penetrates the through hole.

18. The pneumatic nail gun of claim 1, wherein the insurance topper element has a stopping end which blocks the travel of the insurance unit, and the insurance stopper element has a control end at the opposite side for linking the action of the valve lever to the second trigger.

19. The pneumatic nail gun of claim 1, wherein the auxiliary insurance mechanism further comprises a conveying mechanism connected between the second trigger and the insurance stopper element.

20. The pneumatic nail gun of claim 18, wherein a long-axis direction of the nail-gun main body is a first direction, a long-axis direction of the auxiliary handle is a second direction, the shifting path of the insurance unit is a third direction, and the first, second and third directions are vertical to each other.
